(19) United States
(12) Patent Application Publication
(10) Pub. No.: US 2023/0014901 A1
(43) Pub. Date: Jan. 19, 2023

(54) CATION EXCHANGE POLYMERS AND ANION EXCHANGE POLYMERS AND CORRESPONDING (BLEND) MEMBRANES MADE OF POLYMERS CONTAINING HIGHLY FLUORINATED AROMATIC GROUPS, BY WAY OF NUCLEOPHILIC SUBSTITUTION

(71) Applicant: UNIVERSITÄT STUTTGART, Stuttgart (DE)

(72) Inventors: Jochen KERRES, Stuttgart (DE); Vladimir ATANASOV, Herrenberg (DE); Hyeongrae CHO, Stuttgart (DE)

(21) Appl. No.: 17/777,397

(22) PCT Filed: Nov. 17, 2020
(86) PCT No.: PCT/EP2020/082403

§ 371 Date: May 26, 2022

(30) Foreign Application Priority Data
Nov. 18, 2019 (DE) 10 2019 008 024.6

(51) Int. Cl. C08J 7/12; C08J 5/22; H01M 8/1039; H01M 8/1032; H01M 8/18; B01J 47/12; B01J 41/07; B01J 41/14; C25B 13/08; B01D 71/82; B01D 71/32; B01D 67/00; B01D 61/44

(52) U.S. Cl. CPC C08J 7/12; C08J 5/2237; H01M 8/1039; H01M 8/1032; H01M 8/188; B01J 47/12; B01J 41/07; B01J 41/14; C25B 13/08; B01D 71/82; B01D 71/32; B01D 67/00931; B01D 61/44; C08J 2325/18; H01M 2008/1095

(57) ABSTRACT

The present invention relates to new anion exchange polymers and (blend) membranes made from polymers containing highly fluorinated aromatic groups by means of nucleophilic substitution and processes for their production by means of nucleophilic aromatic substitution and their areas of application in membrane processes, in particular in electrochemical membrane processes such as fuel cells, electrolysis and redox flow batteries.

The present invention relates to new anion exchange polymers and (blend) membranes made from polymers containing highly fluorinated aromatic groups by means of nucleophilic substitution and processes for their production by means of nucleophilic aromatic substitution and their areas of application in membrane processes, in particular in electrochemical membrane processes such as fuel cells, electrolysis and redox flow batteries.

It is known from the literature that perfluoroarylenes can undergo nucleophilic substitution reactions. Recent publications have shown that polymers containing perfluoroarylated building blocks can be chemically modified in a polymer-analogous reaction; C. R. Becer, K. Babiuch, D. Pilz, S. Hornig, T. Heinze, M. Gottschaldt and U. S. Schubert, Macromolecules 2009, 42, 2387-2394; C. R. Becer, K. Kokado, C. Weber, A Can, Y Chujo, U. S. Schubert, Journal of Polymer Science: Part A: Polymer Chemistry, 2010, 48, 1278-1286. The authors also demonstrated the activating effect of the perfluorinated building blocks on the C—F bond through a “click” reaction between thiol-based nucleophiles and poly(pentafluorostyrene). Another example of a nucleophilic aromatic substitution reaction on F-containing aromatics is the reaction of a polymer of decafluorobiphenyl and 4,4′-thiodibenzenethiol, in which the S-bridges had previously been oxidized to sulfone bridges with H₂O₂, with NaSH, at which all F of the octafluorobiphenyl building block of the polymer had been replaced by SH groups. In the next reaction step, the SH groups were then oxidized with H₂O₂ to SO₃H groups, with hypersulfonated aromatic polymers having been obtained; Shogo Takamuku, Andreas Wohlfarth, Angelika Manhart, Petra Rader, Patric Jannasch, Polym. Chem., 2015, 6, 1267-1274. An example of nucleophilic substitution of a polymer with aromatic Fs activated for nucleophilic substitution in the side chain is a publication by Guiver, Kim et al, in which the F of the 4-fluorosulfonyl side group was nucleophilically substituted by the strong N-base tetramethylguanidine (Dae Sik Kim, Andrea Labouriau, Michael D. Guiver, Yu Seung Kim, Chem. Mater. 2011, 23, 3795-3797). A few examples of a nucleophilic C—P bond formation of perfluorinated arylenes with nucleophilic organophosphorus compounds are known from the literature (L. I. Goryunov, J. Grobe, V. D. Shteingarts, B. Krebs, A. Lindemann, E.-U. Wüthwein, Chr. Mueck-Lichtenfeld, Chem. Eur. J. 2000, 6, 24, 4612-4622; R. M. Bellabarba, M. Nieuwenhuyzen and G. C. Saunders, Organometallics 2003, 22, 1802-1810; B. Hoge and P. Panne, Chem. Eur. J. 2006, 12, 9025-9035), including work in which the 4-F on the polymer poly(pentafluorostyrene) was nucleophilically substituted by tris(trimethylsilyl)phosphite, and the polymeric phosphonic acid silyl ester was then hydrolyzed by water to form the free phosphonic acid (V. Atanasov, J. Kerres, Macromolecules 2011, 44, 6416-6423). Another work involved the substitution of the 4-F of poly(pentafluorostyrene) by the SH moiety using NaSH, followed by oxidation of the SH group to the sulfonic acid group SO₃H with hydrogen peroxide (V. Atanasov, M. Burger, S. Lyonnard, G Gebel, J. Kerres, Solid State Ionics, 2013, 252, 75-83).

In the context of the present invention, it was surprisingly found that the nucleophilic substitution of the F of activated aromatic C—F bonds of perfluorinated arylenes (low molecular weight compounds, oligomers and polymers) anion exchange polymers can be obtained, which are characterized by high chemical stability, and therefore can be used advantageously in electrochemical applications such as alkaline or acidic fuel cells, alkaline or acidic electrolyzers, or redox flow batteries.

The object of the present invention is accordingly characterized by the embodiments characterized in the claims.

The figures show:

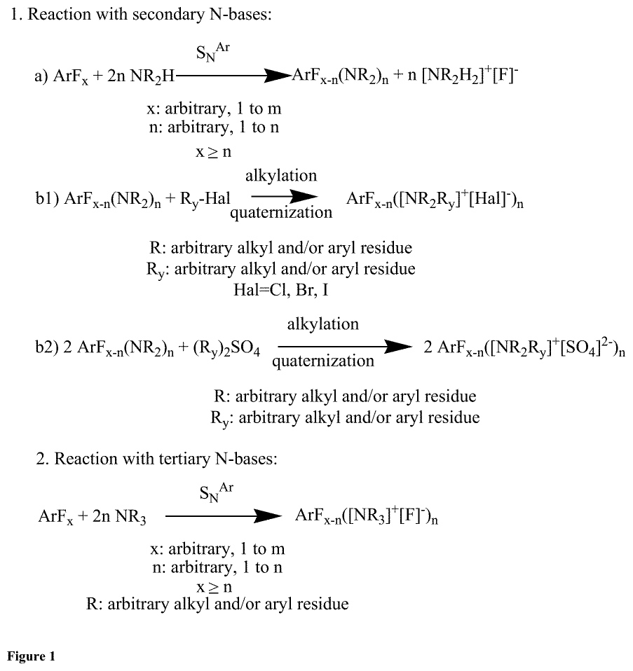

FIG. 1 shows the reaction according to the invention of a perfluorinated aryl with a strong organic secondary N-base.

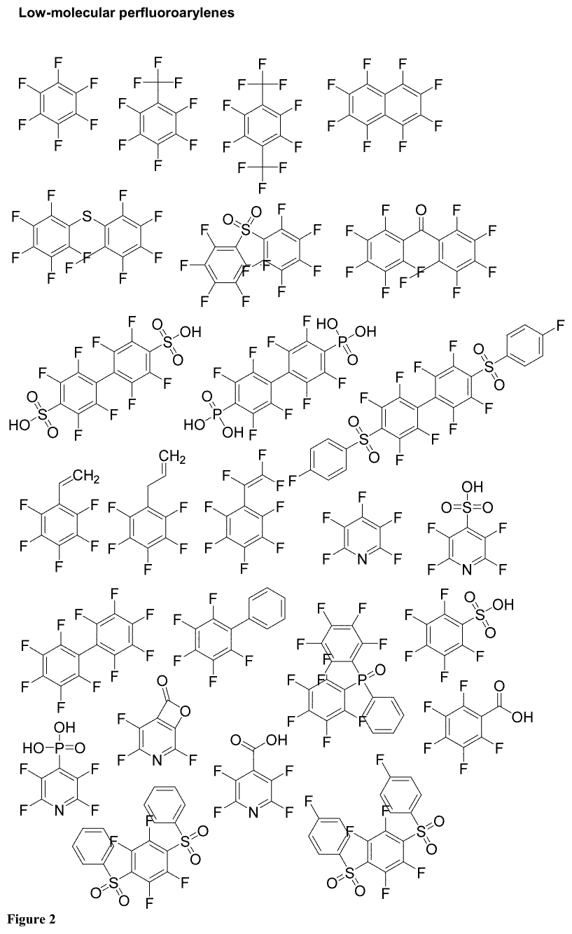

FIG. 2 shows non-limiting examples of perfluorinated low molecular weight arenes which can be used according to the invention.

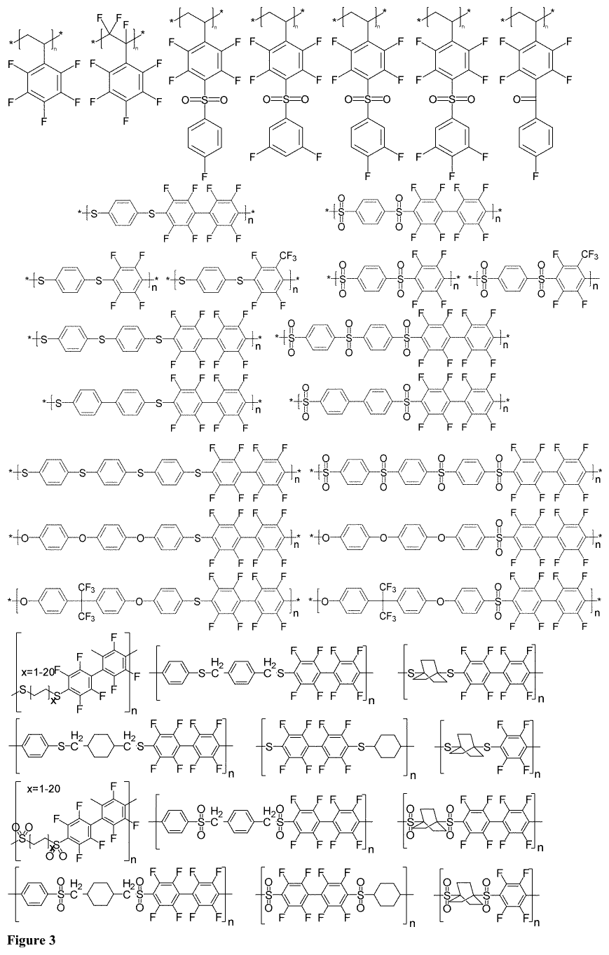

FIG. 3 shows non-limiting examples of perfluorinated high molecular weight arenes (polymers) that can be used according to the invention.

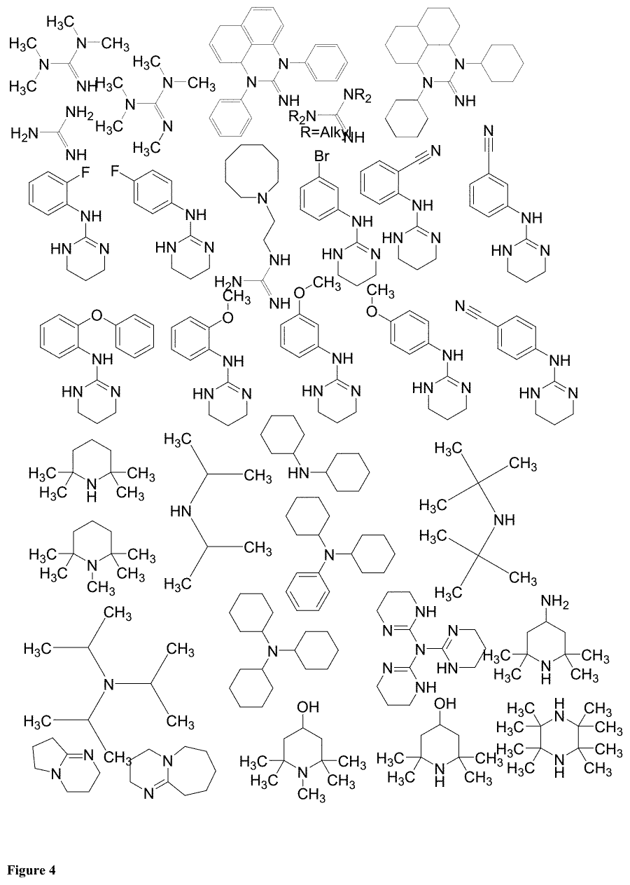

FIG. 4 shows non-limiting examples of strong N-bases for S_{N}^{Ar} reactions with perfluorinated arenes.

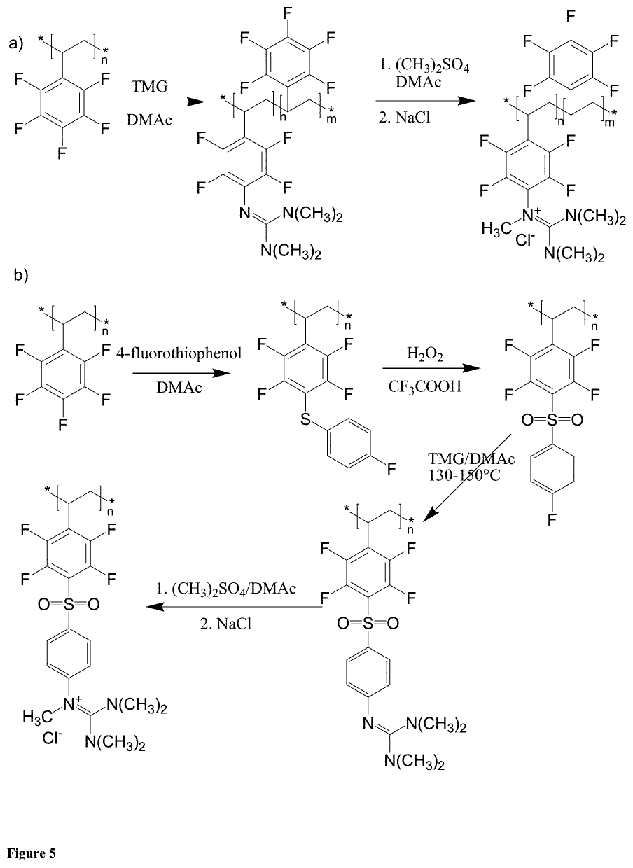

FIG. 5 shows the preparation of anion exchange polymers with guanidinium groups based on poly (pentafluorostyrene); a) partial substitution of the 4-F of PPFSt with tetramethylguanidine followed by alkylation; b) Substitution of the 4-F of PPFSt with 4-fluorothiophenol, followed by oxidation, followed by reaction with tetramethylguanidine, followed by alkylation.

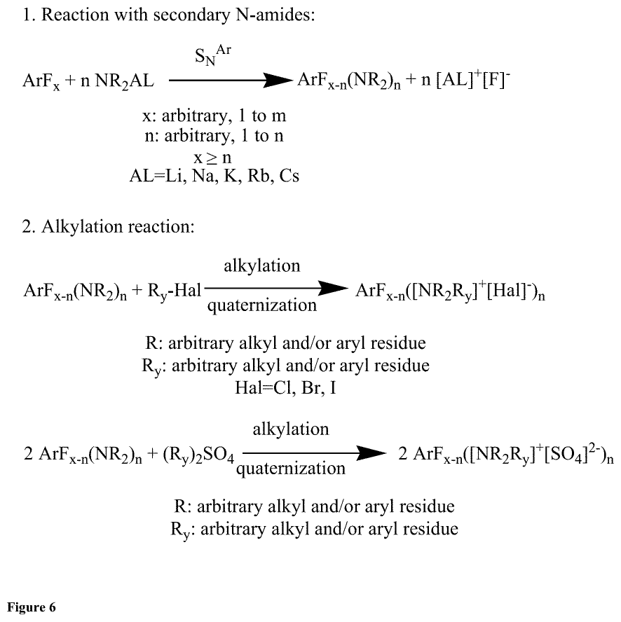

FIG. 6 shows the reaction of an alkali metal amide with a perfluorinated arene (S_{N}^{Ar}) followed by quaternization of the formed tertiary amino groups with an alkylating agent (haloalkane, benzyl halide, dialkyl sulfate, etc.).

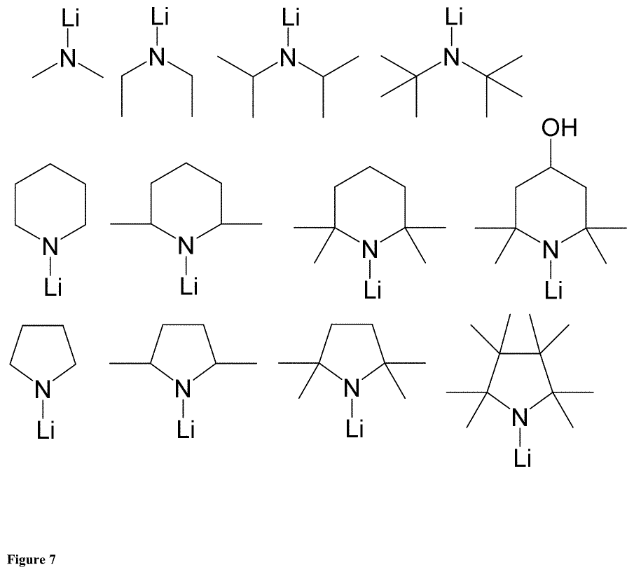

FIG. 7 shows non-limiting examples of lithium amides for S_{N}^{Ar} reaction with perfluorinated arenes.

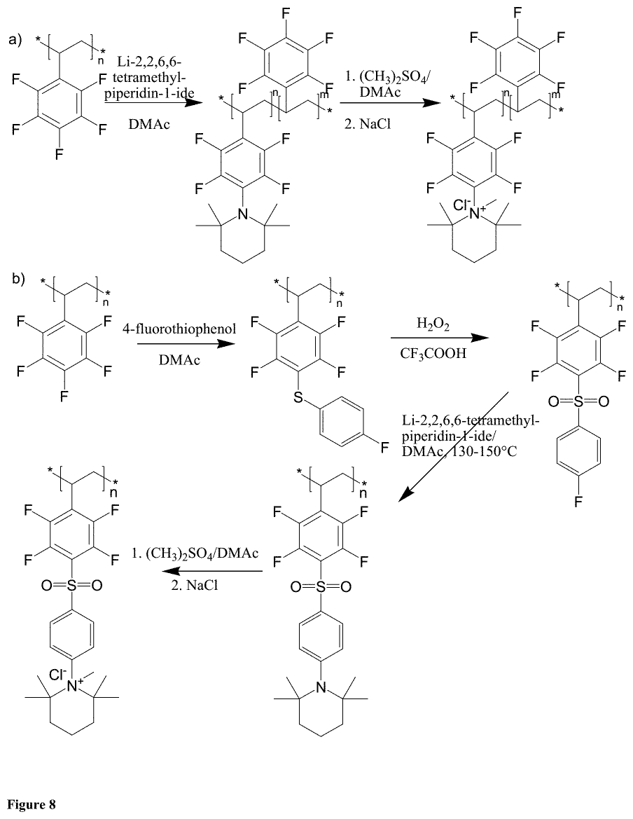

FIG. 8 shows the reaction of poly(pentafluorostyrene) with lithium-2,2,6,6-tetramethylpiperidine-1-ide (a) and reaction of 4-fluorothiophenol substituted and subsequently oxidized poly(pentafluorostyrene) with lithium-2,2,6,6-tetramethylpiperidine-1-ide (b) followed by alkylation of these polymers.

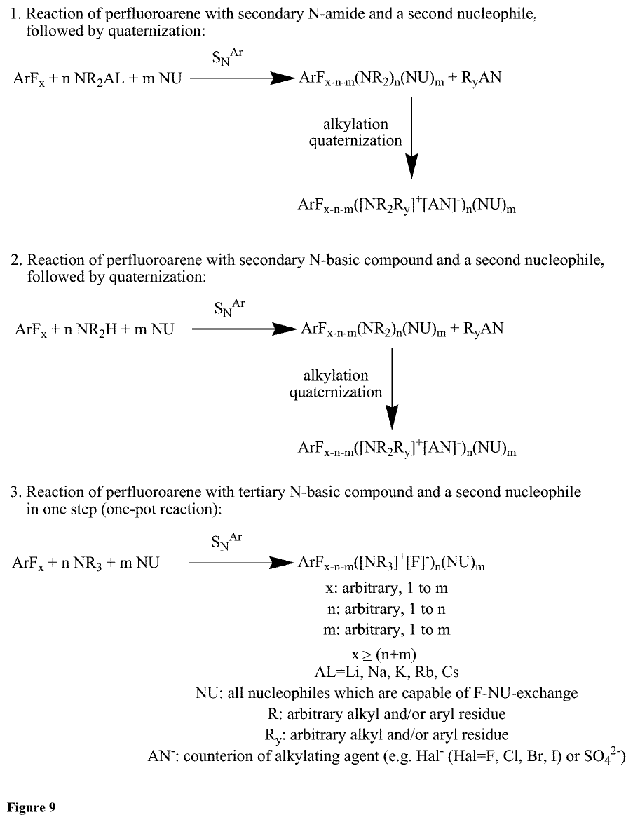

FIG. 9 shows the reaction schemes for the reaction of perfluoroarenes with secondary or tertiary N-bases or secondary N-amides and a second nucleophile.

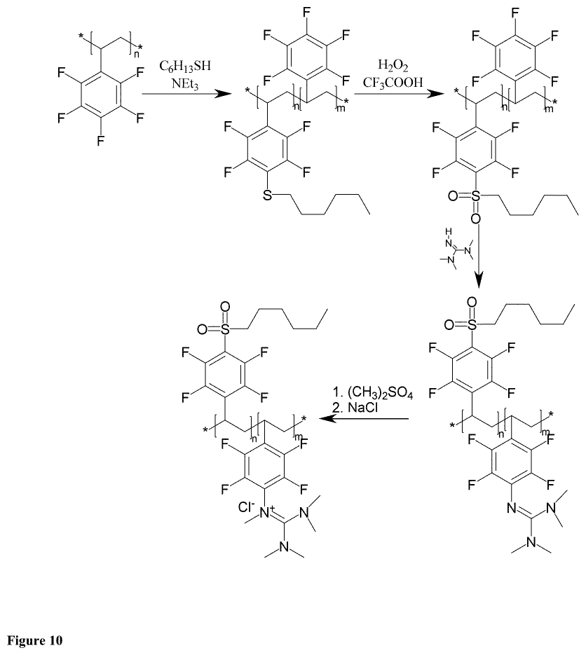

FIG. 10 shows the reaction of PPFSt with hexanethiol, followed by oxidation, followed by reaction with tetramethylguanidine, followed by alkylation with dimethyl sulfate.

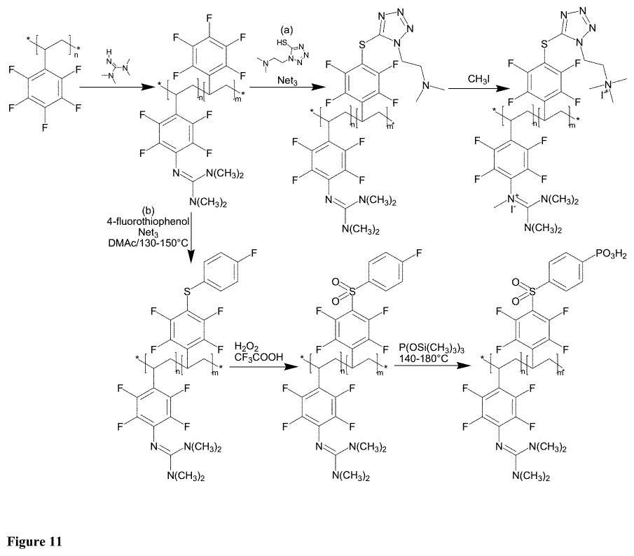

FIG. 11 shows the reaction of poly(pentafluorostyrene) with tetramethylguanidine, followed by reaction (a) with 1-(2-dimethylaminoethyl)-5-mercaptotetrazole, followed by quaternization with methyl iodide, or (b) with 4-fluorothiophenol, followed by oxidation with H₂O₂, followed by phosphonation with tris(trimethylsilyl)phosphite.

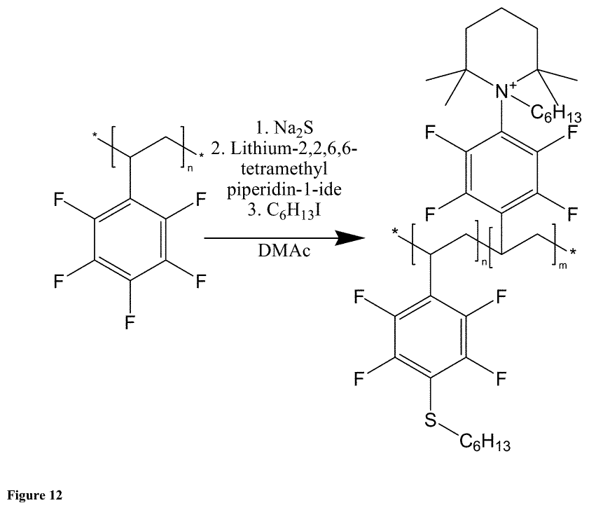

FIG. 12 shows the reaction of poly(pentafluorostyrene) with lithium 2,2,6,6-tetramethylpiperidine-1-ide and Na₂S, followed by alkylation with hexyl iodide as a “one-pot reaction”.

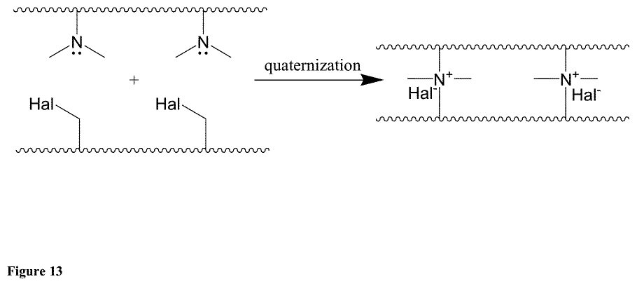

FIG. 13 shows the reaction of polymer according to the invention with tertiary N-basic groups with halomethylated polymer with quaternization and covalent crosslinking.

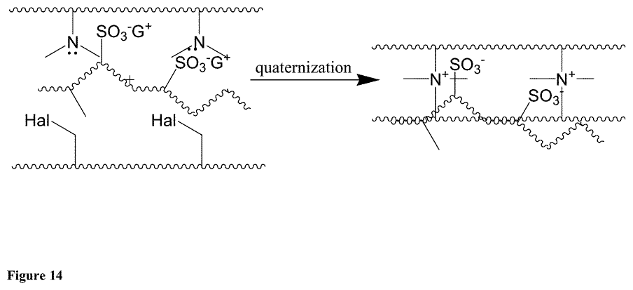

FIG. 14 shows the blending of a polymer according to the invention with N-basic groups with a halomethylated and a sulfonated polymer with the formation of covalent and ionic crosslinking sites.

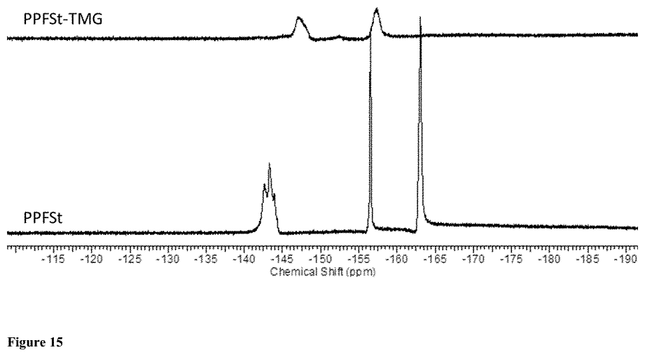

FIG. 15 shows the 19F-NMR spectrum of PPFSt-TMG (top) and PPFSt (bottom).

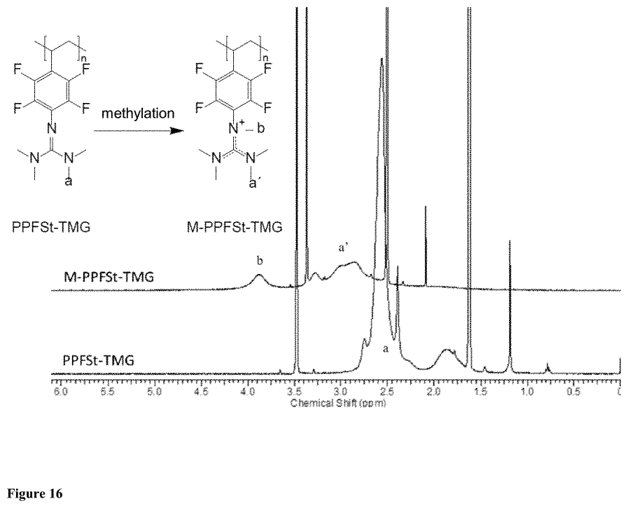

FIG. 16 shows the 1H-NMR spectrum of M-PPFSt-TMG (top) and PPFSt-TMG (bottom).

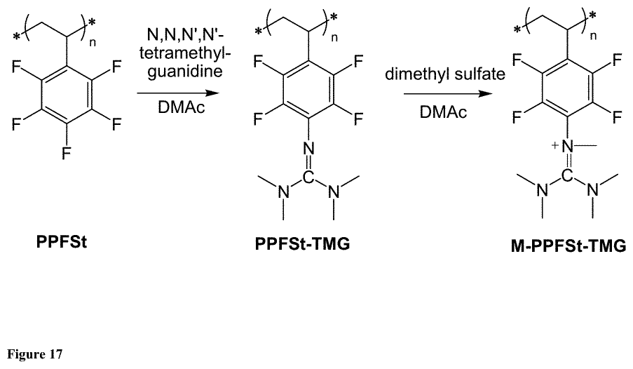

FIG. 17 shows the modification of PPFSt with tetramethylguanidine and its methylation.

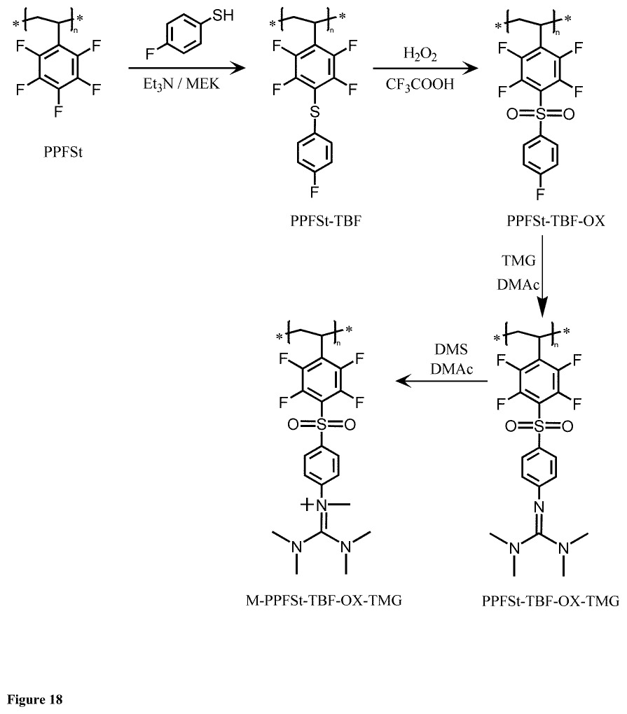

FIG. 18 shows the synthesis of M-PPFSt-TBF-OX-TMG.

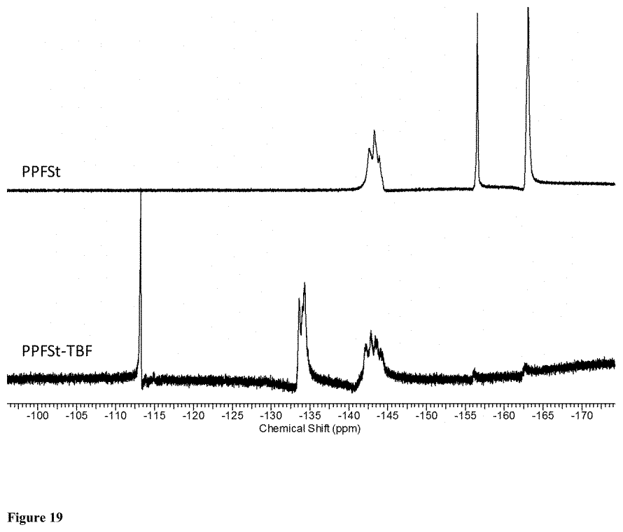

FIG. 19 shows the 19F-NMR spectrum of PPFSt (top) and PPFSt-TBF (bottom).

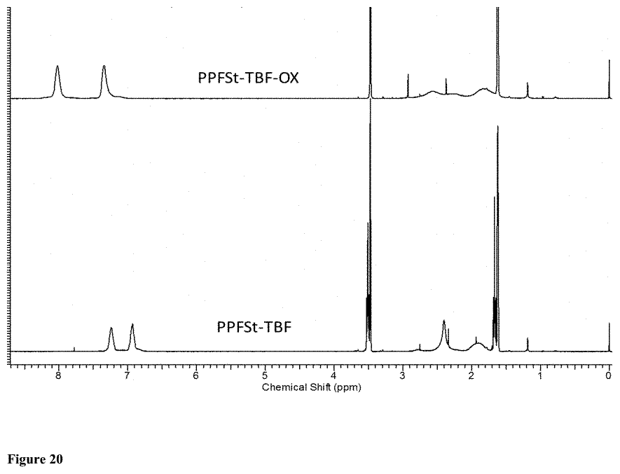

FIG. 20 shows the 1H-NMR spectrum of PPFSt-TBF-OX (top) and PPFSt-TBF (bottom).

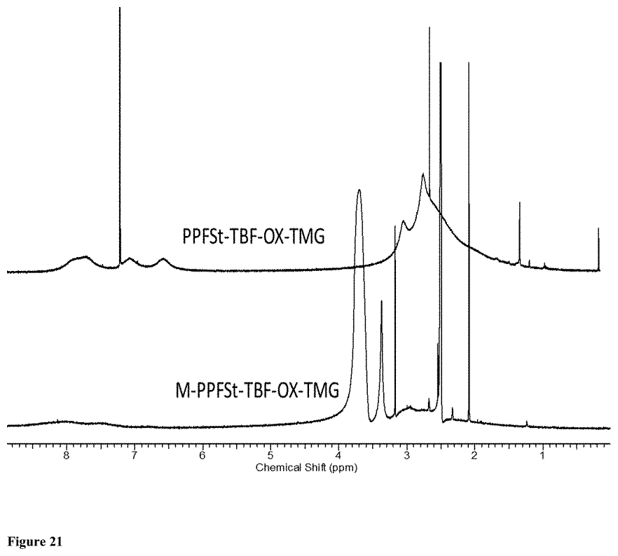

FIG. 21 shows the 1H-NMR spectrum of PPFSt-TBF-OX-TMG (top) and M-PPFSt-TBF-OX-TMG (bottom).

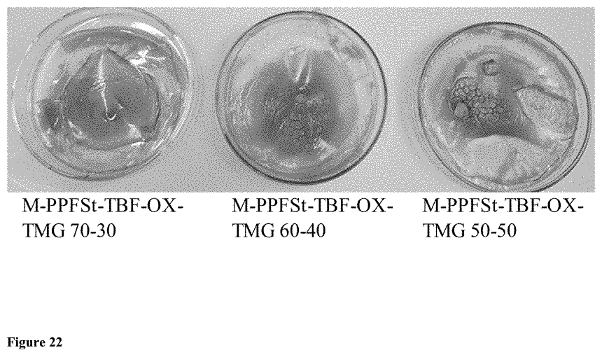

FIG. 22 shows photographs of prepared mixed membranes.

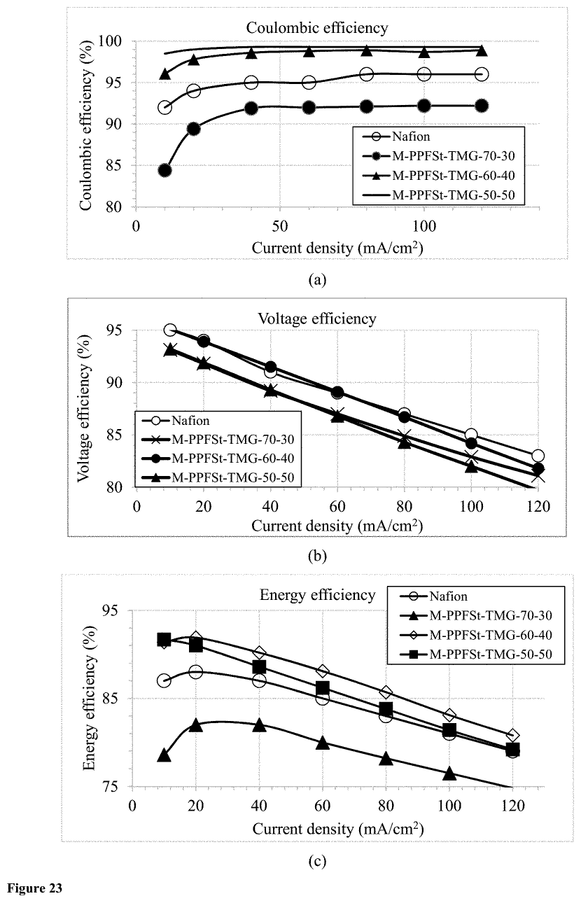

FIG. 23 shows CE (a), VE (b) and EE (c) of blend membranes and a Nafion 212 membrane.

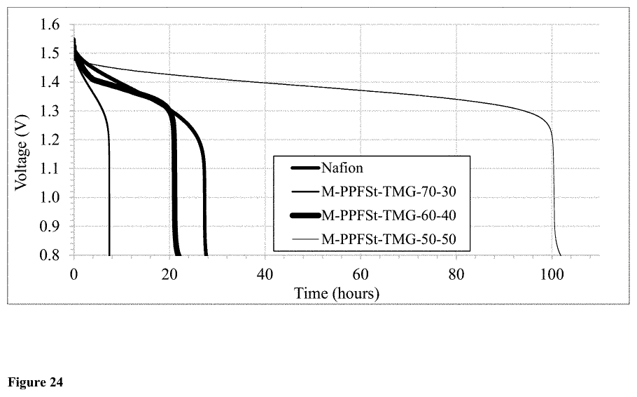

FIG. 24 shows the self-discharge time of mixed membranes and a Nafion 212 membrane.

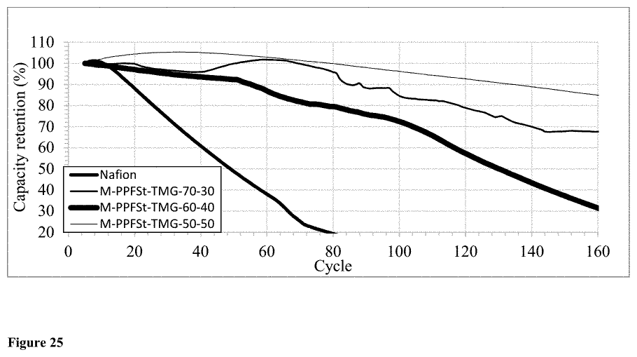

FIG. 25 shows a long term cycling test of blend membranes and of a Nafion 212 membrane.

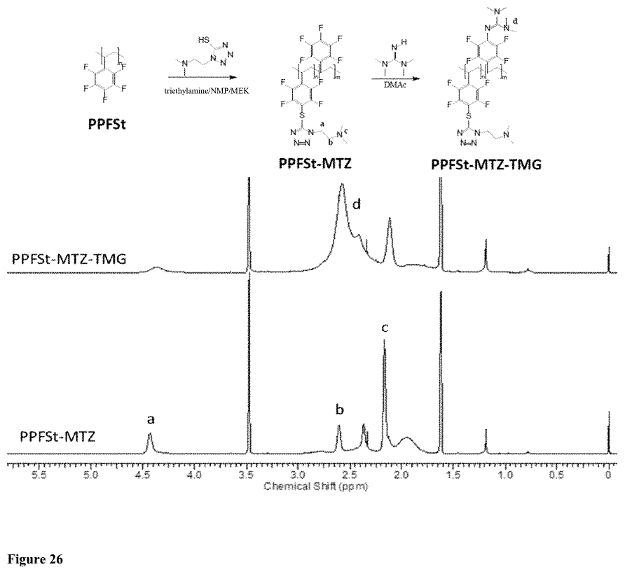

FIG. 26 shows the 1H-NMR spectra of PPFSt-MTZ-TMG (top) and PPFSt-MTZ (bottom).

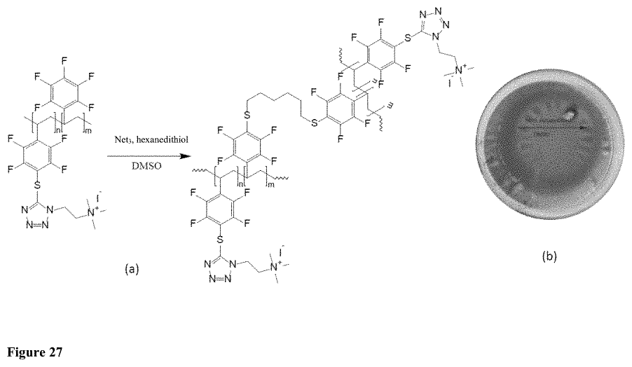

FIG. 27 shows the reaction scheme for the production of a crosslinked membrane (a) and photograph of a crosslinked PPFSt-MTZ membrane (b).

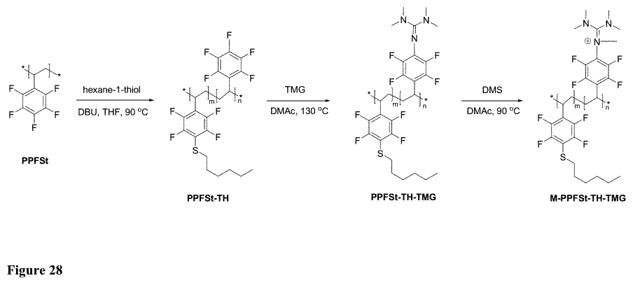

FIG. 28 shows the post-modification of PPFSt with mercaptohexyl and tetramethylguanidine units.

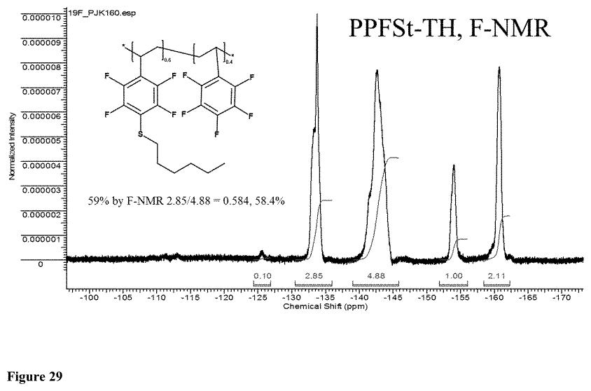

FIG. 29 shows the 19^{F}-NMR spectrum of PPFSt-TH.

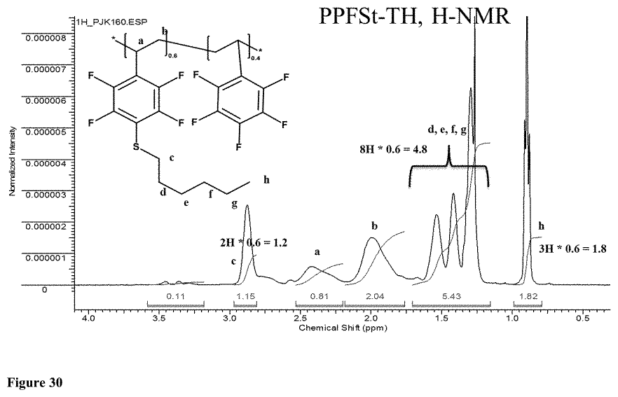

FIG. 30 shows the 1^{H}-NMR spectrum of PPFSt-TH.

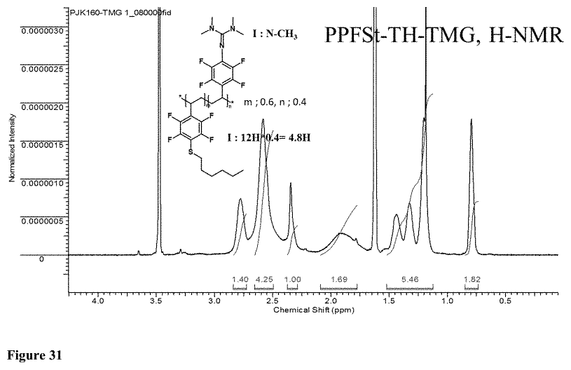

FIG. 31 shows the 1^{H}-NMR spectrum of PPFSt-TH-TMG.

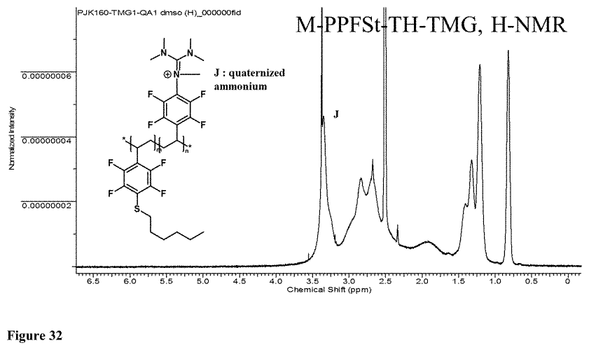

FIG. 32 shows the 1^{H}-NMR spectrum of M-PPFSt-TH-TMG.

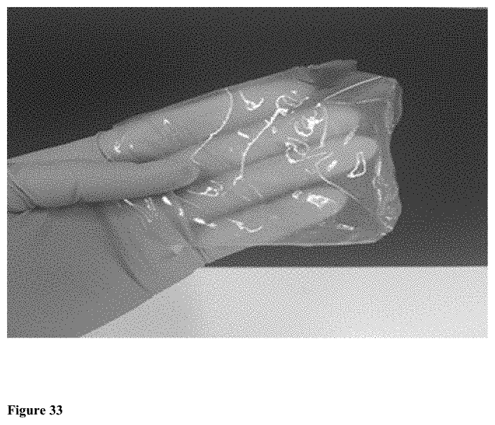

FIG. 33 shows the photograph of a prepared M-PPFSt-TH-TMG membrane.

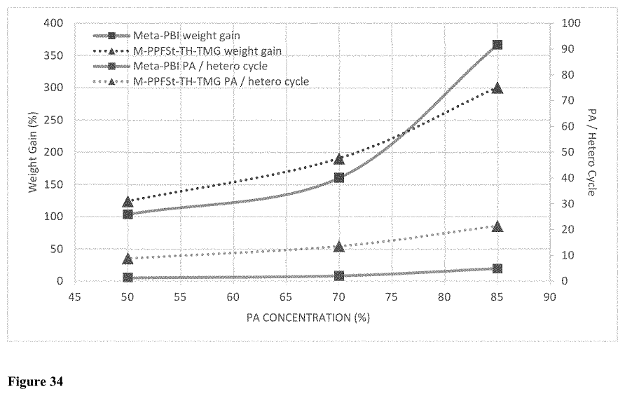

FIG. 34 shows the PA doping results of membranes.

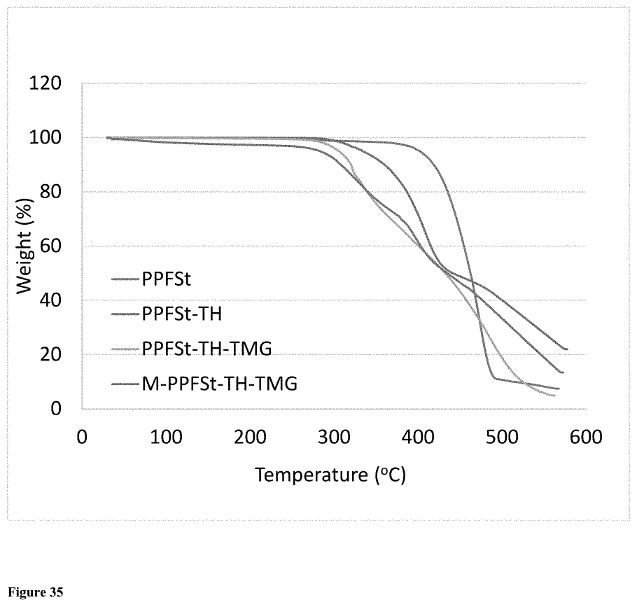

FIG. 35 shows the thermal stabilities of polymers.

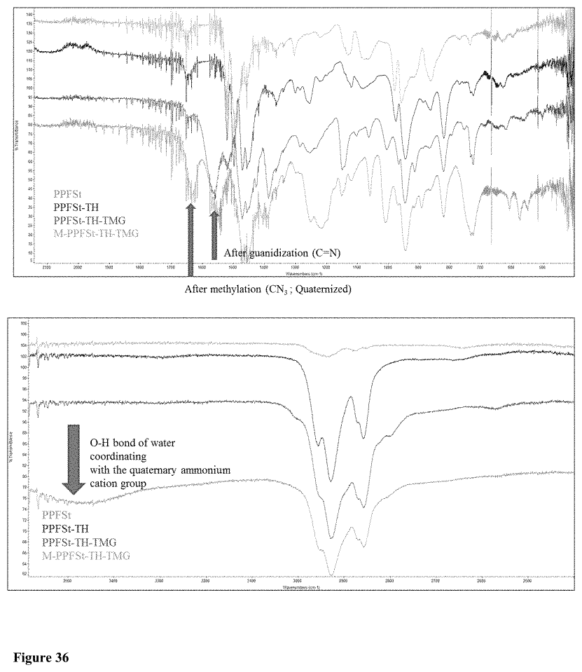

FIG. 36 shows the FT-IR spectra of polymers.

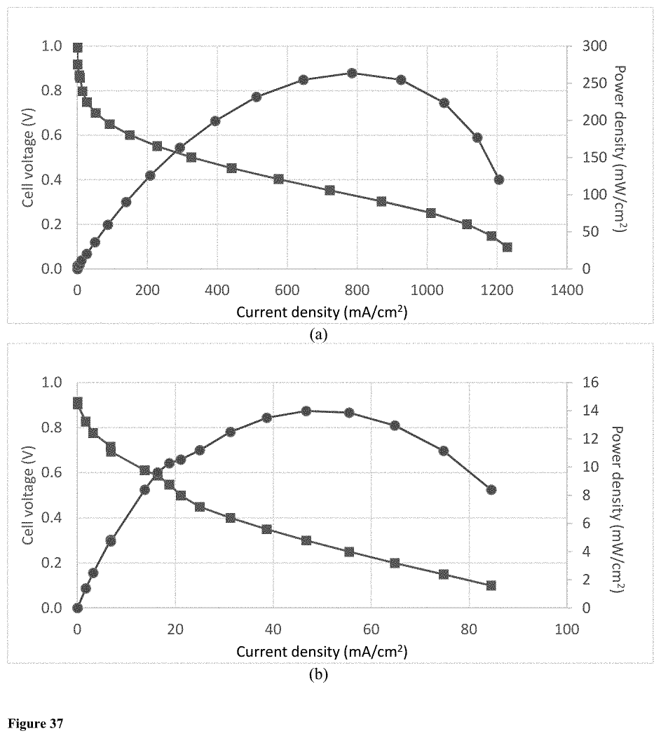

FIG. 37 shows the fuel cell performance of m-PBI (a) and M-PPFSt-TH-TMG (b).

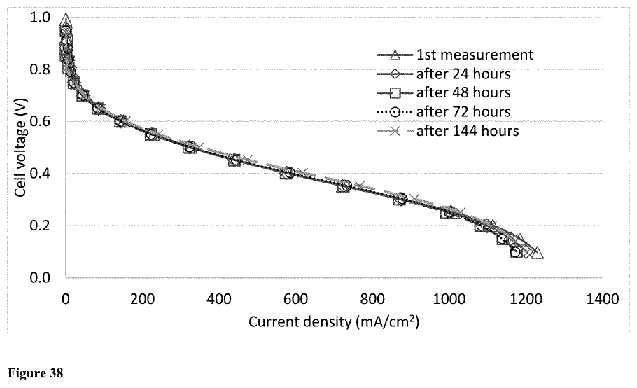

FIG. 38 shows the characteristics of the M-PPFSt-TH-TMG membrane over time.

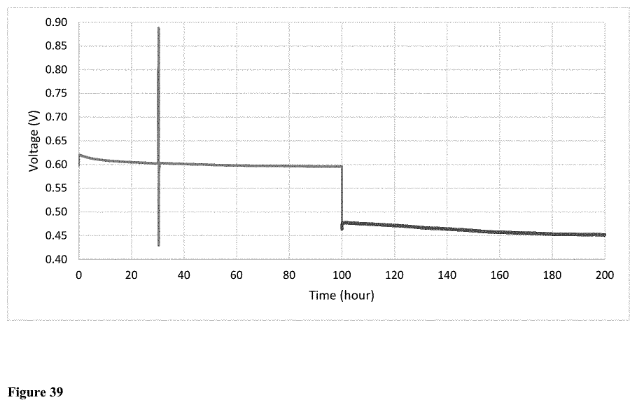

FIG. 39 shows the short-term stability of M-PPFSt-TH-TMG at constant current density in the fuel cell.

The first embodiment of the invention relates to the reaction of a perfluorinated aryl with a strong organic secondary or tertiary N-base, where the perfluorinated aryl may be a small molecule, an oligomer or a polymer. The first embodiment of the invention is shown in FIG. 1. When a secondary amine is reacted with the fluorinated arene, 1 or any F is nucleophilically exchanged for the amine, with the H⁺ abstracted during the S_{N}^{Ar} reaction protonating additional amine molecule(s). In the second step, the resulting tertiary amino group is quaternized with an alkylating agent. The alkylating agent can be of low molecular weight and is then selected from haloalkanes (CₙH₂₊₁Hal, n=1-20, benzyl halide PhCH₂Hal, Hal=I, Br, Cl) or dialkyl sulfates R₂SO₄ (R=alkyl CₙH₂ₙ₊₁, n=1-12, benzyl), or dihaloalkanes (CₙH₂ₙHal₂, Ph(CH₂Hal)₂, n=1-20, Hal=I, Br, Cl). The alkylating agent can also have a high molecular weight and is then any selected polymer with halomethyl groups CH₂Hal, Hal=Cl, Br, I. If dihaloalkanes or polymers with halomethyl groups are used for the quaternization, the polymers according to the invention are simultaneously crosslinked by the quaternization. If a tertiary amine (low or high molecular weight) is used for the S_{N}^{Ar} reaction with the fluorinated arene, a quaternary ammonium salt is formed as an anion exchange group in just one step. In the case of amines with at least two tertiary amino groups in the molecule (low or high molecular weight), crosslinked anion exchange membranes are formed as a result of the S_{N}^{Ar} reaction.

FIG. 2 shows non-limiting examples of suitable low molecular weight perfluorinated arylenes, and FIG. 3 shows non-limiting examples of polymeric perfluorinated arylenes. FIG. 4 shows non-limiting examples of suitable secondary or tertiary N-bases.

FIG. 5 shows the production of an anion exchange polymer with guanidinium anion exchange groups based on poly (pentafluorostyrene). In step a), the reaction of poly (pentafluorostyrene) with tetramethylguanidine is shown, followed by an alkylation of the polymer modified with the guanidine. In step b) the poly (pentafluorostyrene) is first reacted with 4-fluorobenzenethiol, followed by oxidation of the S-bridges to SO₂ bridges with hydrogen peroxide, followed by reaction with tetramethylguanidine and finally alkylation with dimethyl sulfat.

The second embodiment of the invention relates to strong N-bases in which an NH bond is replaced by an N-alkali metal bond. These alkali metal-nitrogen compounds are alkali metal amides. The alkali metal can be Li, Na, K, Rb or Cs, with Li being preferred. The alkali metal amides react with the perfluorinated arene (low molecular weight, oligomer or polymer) with nucleophilic alkali metal-F-exchange (S_{N}^{Ar}), as shown in FIG. 6. In the second step, the tertiary basic N-compounds formed are then alkylated with an alkylating agent. The selection of an alkylating agent is in principle arbitrary, preference being given to haloalkanes, benzyl halides and dialkyl sulfates as alkylating agents.

In principle, any alkali metal amides can be reacted with the perfluoroarenes according to the invention. Lithium amides are preferred in the invention. A non-limiting selection of lithium amides is shown in FIG. 7.

FIG. 8 shows the second embodiment of the invention using the example of the reaction of poly(pentafluorostyrene) with lithium 2,2,6,6-tetramethylpiperidine-1-ide (step a)) and the example of the reaction of with 4-fluorothiophenol substituted and subsequently oxidized poly(pentafluorostyrene) with lithium 2,2,6,6-tetramethylpiperidine-1-ide (step b)), the poly(pentafluorostyrene) substituted with the piperidine being alkylated in a final step to give the anion exchange polymer. The particular advantage of these polymers lies in the good spatial shielding of the quaternized N by the methyl groups of the 1,2,2,6,6-pentamethylpiperidinium cation, which gives these polymers very good stability in an alkaline medium (if the counterion is OH⁻) making them excellent and long-term stable anion conductors in alkaline anion exchange membrane electrolysis (AEME) or in alkaline anion exchange membrane fuel cells (AEMFC).

A third embodiment of the invention relates to the substitution of additional F of the low molecular weight, oligomeric or high polymeric perfluoroarenes containing tertiary amino groups or quaternary ammonium groups by other nucleophiles. In principle, the type of nucleophile or nucleophiles substituting the F is not restricted, but all nucleophiles that react with perfluoroarenes with nucleophilic exchange of the F are suitable. FIG. 9 shows a schematic of the low molecular weight, oligomeric and polymeric substances obtained in the third embodiment of the invention when the low molecular weight, oligomeric or polymeric compound containing tertiary amino groups or quaternary ammonium salts is reacted with a second nucleophile.

However, the following nucleophiles are preferred (without limiting the choice of nucleophiles):
R—SH, [R—S]⁻[C⁺] (R=any alkyl or aryl radical, C⁺=1-valent cation such as metal cation, ammonium ion, pyridinium ion, imidazolium ion, guanidinium ion, etc.). The nucleophile can also contain more than 1 SH or SC group. Non-limiting examples of R—SH are alkyl thiols CₙH₂ₙ₊₁SH (n=2-20), non-limiting examples of RSC are alkyl or aryl or benzyl thiolates with alkali metal cation (alkali metal=Li, Na, K, Rb, Cs) or any ammonium ion as counterion. Non-limiting examples of compounds containing multiple SH or SC groups are benzenedithiols (ortho-, meta- or para-), naphthalenedithiol, dibenzyldithiols, alkanedithiols HS—CₙH₂ₙ—SH (n=2-20) or their salts with metal or ammonium counterions with no limitation on the nature of the counter(cat)ion.
P(OSi(CH₃)₃)₃ (tris(trimethylsilyl)phosphite)
AL₂S and ALSH (AL=alkali metal counterion)

The third embodiment for obtaining the low molecular weight, oligomeric and polymeric compounds according to the invention can be obtained in the following sequence:
(1) The low molecular weight, oligomeric or polymeric perfluoroarene is first reacted with the second nucleophile. If the second nucleophile is RSH or RSC, the resulting thioether bridge can then be oxidized to the sulfone bridge. If the nucleophile is AL₂S or ALSH, the resulting SH group can be oxidized to the SO₃H group. This is followed by reaction with the secondary or tertiary N-base or the secondary N-amide, followed by alkylation in the case of secondary N-bases or secondary N-amides. This reaction sequence is shown in FIG. 10 by way of non-limiting example of the reaction of poly(pentafluorostyrene) with hexanethiol, followed by oxidation of the thio to sulfone bridge, followed by reaction with tetramethylguanidine, followed by quaternization with dimethyl sulfate. The special advantage of this polymer is that the hexylsulfone group serves as an integrated “plasticizer” functional group of this polymer, which significantly reduces the brittleness of the anion exchange polymer, which is very advantageous for the application of this anion exchange polymer in a membrane fuel cell. The longer the alkyl chain, the stronger the plasticizer effect of the alkyl sulfone group.
(2) The low molecular weight, oligomeric or polymeric perfluoroarene is first reacted with the secondary or tertiary basic N-compound or secondary N-amide, optionally followed by N-alkylation to the quaternary N-salt, followed by reaction with the second nucleophile. This reaction sequence is illustrated by three non-limiting examples: (a) the reaction of a partially fluorinated aromatic polysulfone with tetramethylguanidine followed by phosphonation with tris(trimethylsilyl)phosphite, in FIG. 11, and (b) the reaction of poly(pentafluorostyrene) with tetramethylguanidine, followed by reaction with 1-(2-dimethylaminoethyl)-5-mercaptotetrazole, followed by quaternization with methyl iodide, and (c) by reaction of poly(pentafluorostyrene) with tetramethylguanidine, followed by reaction of the remaining 4-F of the poly(pentafluorostyrene) with 4-fluorothiophenol, followed by oxidation of the thio bridges of the polymer with H₂O₂ to sulfone bridges, followed by phosphonation the 4-F of the phenylsulfone side chain. Calculations of the pKA value of the phosphonic acid group using the ACD software have shown that the phosphonic acid group at this point in the molecule is a strong acid group due to the strong —I effect of the sulfone bridge, which makes this polymer a promising proton conductor for high temperature fuel cells (temperature range 100-250° C.) due to the intrinsic conductivity of the phosphonic acid group.
(3) The low molecular weight, oligomeric or polymeric perfluoroarene is simultaneously reacted with a secondary or tertiary N-base or a secondary N-amide. This reaction is shown in FIG. 12 as a “one-pot reaction” using the non-limiting example of the reaction of poly(pentafluorostyrene) and a partially fluorinated aromatic polysulfone with lithium 2,2,6,6-tetramethylpiperidine-1-ide and Na₂S.

It was also found, surprisingly, that the novel polymers according to the invention in all of the above three embodiments can be readily converted with other suitable polymers to form blend membranes. A non-limiting selection of blend membranes according to the invention is listed below:
Polymers of the 1st and 2nd embodiment (polymeric perfluorinated arenes with quaternary N-basic groups (see FIG. 1 and FIG. 6)) are blended with basic polymers in any mixing ratio, the choice of basic polymers is not limited, but polybenzimidazoles because of their high mechanical and thermal as well as chemical stability are preferred. Anion exchange blends are obtained in which the basic blend component serves to mechanically, thermally and chemically stabilize the blend.
Polymers of the 1st and 2nd embodiment (polymeric perfluorinated arenes with tertiary N-basic groups (see FIG. 1 and FIG. 6) are blended with cation exchange polymers in any mixing ratio, with the selection of the cation exchange polymers being unrestricted, and the cation exchange polymers may either have sulfonate groups (—SO₃⁻G⁺), phosphonate groups (PO₃²⁻(G⁺)₂ or carboxylate groups (COO⁻G⁺) with G⁺=counterion=H⁺, metal cation, ammonium, guanidinium, pyridinium, imidazolium . . . ), with sulfonate and phosphonate groups being preferred as cation exchange groups.
Polymers of the 1st and 2nd embodiment (polymeric perfluorinated arenes with tertiary N-basic groups (see FIG. 1 and FIG. 6) are blended in any mixing ratio with polymers containing CH₂Hal groups (Hal=Cl, Br, I). Quaternization reactions between the tertiary N-basic groups of the polymers of the 1st and 2nd embodiment and the halomethylated polymer result in a covalent crosslinking of these blend membranes (FIG. 13).
Polymers of the 1st and 2nd embodiment (polymeric perfluorinated arenes with quaternary N-basic groups (see FIG. 1 and FIG. 6)) are blended with sulfonated, phosphonated or carboxylated cation exchange polymers and with halomethylated polymers in any mixing ratios. The quaternization reaction between halomethyl groups and the tertiary amino groups leads to covalent crosslinking and at the same time to the formation of anion exchange groups, which in turn form ionic crosslinking points with the cation exchange groups of the cation exchange polymer blend component (FIG. 14).
Polymers of the third embodiment (perfluoroarene with a quaternary N-basic functional group and another functional group introduced nucleophilically (see FIG. 9)) are blended with a basic polymer, the choice of possible basic polymers not being restricted, but polybenzimidazoles are preferred. In these blends, the basic polymer acts as a chemically, mechanically and thermally stabilizing blend component.
Polymers of the third embodiment (perfluoroarene with a tertiary N-basic functional group and a further functional group introduced nucleophilically (see FIG. 9)) are made with cation exchange polymers (sulfonated, phosphonated, carboxylated polymers) and/or basic polymers and/or with Polymers containing halomethyl groups —CH₂Hal (Hal=Cl, Br, I) are blended. If a halomethylated polymer is used as the blend component, reaction of the halomethyl groups with the tertiary N-basic groups results in quaternization and thus covalent crosslinking of the blend membrane (see above).

The present invention is explained in more detail by the following examples without being restricted thereto.

### 1. Reaction of Poly (Pentafluorostyrene) with Tetramethylguanidine Followed by Alkylation of the Substituted Polymer with Dimethyl Sulfate

### 1.1 Synthesis Method of M-PPFSt-TMG

1.1.1 Tetramethylguanidine-Modified PPFSt (PPFSt-TMG)

PPFSt (1 g, 5.15 mmol) was dispersed in DMAc (20 mL) at 130° C. for 2 h in a three-necked round bottom flask equipped with condenser, argon inlet and outlet. After cooling to room temperature, tetramethylguanidine (2.97 g, 25.8 mmol) was added into the reaction solution. The reaction solution was stirred at 130° C. for 24 hours. Then the polymer was precipitated by dropping the polymer solution into water. The polymer obtained was washed several times with plenty of water and dried in an oven at 60° C. for 24 hours. A degree of substitution of 100% was confirmed by 19F-NMR showing 2 peaks after the reaction (ortho and meta positions) (FIG. 15).

1.1.2 Quaternization of PPFSt-TMG (M-PPFSt-TMG)

Quaternization of PPFSt-TMG was performed by methylation using dimethyl sulfate. PPFSt-TMG (1 g, 3.45 mmol) was dissolved in 20 mL of DMAc in a round bottom flask equipped with septum, condenser, argon inlet and outlet for 3 hours at room temperature under an argon atmosphere. After complete dissolution, dimethyl sulfate (1 mL, 10.4 mmol) was slowly added via syringe. The reaction mixture was stirred at 90° C. for 16 hours. After cooling to room temperature, the polymer solution was precipitated in acetone. The polymer obtained was washed twice with acetone and oven dried at 60° C. for 24 hours. 100% DOS was confirmed by ¹H-NMR, showing a complete peak shift of the methyl groups (N—CH₃ (a), from 2.5 ppm to 2.9 ppm), and a new peak can be identified by methylation (b) N—CH₃ are assigned.

1.1.3 Solubility tests of the synthesized polymers

TABLE 1
Solubility of the synthesized polymers in various solvents

| | DMSO | DMAc | THF | acetone | methanol | water | chloroform |
|---|---|---|---|---|---|---|---|
| PPFSt | + | + | ++ | ++ | − | − | − |
| PPFSt-TMG | − | ++ | ++ | ++ | ++ | − | |
| M-PPFSt- | ++ | ++ | − | − | ++ | ++ | − |
| TMG | | | | | | | |

++ soluble; + partially soluble; − insoluble

### 1.2 Synthesis of M-PPFSt-TBF-OX-TMG

Synthesis of PPFSt-TBF: PPFSt (1 g, 5.2 mmol) was dissolved in 40 mL of methyl ethyl ketone (MEK) in a 100 mL three-necked flask equipped with argon inlet, outlet, and condenser. After complete dissolution of PPFSt, triethylamine (7.82 g, 15 equivalents to PPFSt) and 4-fluorobenzenethiol (1.65 mL, 3 equivalents to PPFSt) were added to a polymer solution. Then the reaction mixture was kept at 75° C. for 24 hours. The synthesized polymer was obtained by precipitation in methanol. The polymer was washed several times with methanol and dried in an oven at 60° C. for 18 hours; almost complete substitution determined by ¹⁹F NMR.

Synthesis of PPFSt-TBF-OX: PPFSt-TBF (3 g, 10 mmol) was dispersed in 60 mL of trifluoroacetic acid in a flask fitted with a condenser. Then 10 mL of hydrogen peroxide (30% in water, 100 mmol) was added dropwise to a reaction flask. A reaction solution was stirred at 30° C. for 72 hours, followed by 1 hour at 110° C. After cooling to room temperature, the reaction solution was poured into water to obtain the polymer. The polymer obtained was washed several times with water and dried in an oven at 60° C. for 18 hours; chemical shift of aromatic region indicates successful oxidation from sulfide to sulfone.

Synthesis of PPFSt-TBF-OX-TMG: PPFSt-TBF-OX (3.34 g, 10 mmol) was dissolved in DMAc in a three-necked flask equipped with argon inlet, outlet and condenser. After complete dissolution, TMG (10 mL, 80 mmol) was added into the polymer solution and stirred at 130° C. for 20 h. Then the polymer was isolated by precipitation in water. The polymer obtained was washed several times with water and dried in an oven at 60° C. for 24 hours; partial guanidization confirmed by ¹H-NMR: 3 peaks in the aromatic region and a strong peak at 2.6 ppm due to N—CH₃ from tetramethylguanidine groups.

Synthesis of M-PPFSt-TBF-OX-TMG: Methylation of PPFSt-TBF-OX-TMG was performed with dimethyl sulfate (DMS) in DMAc. PPFSt-TBF-OX-TMG was dissolved in DMAc. After complete dissolution, DMS was added to a polymer reaction solution and the temperature was raised to 90° C. The reaction was mechanically stirred at this temperature for 20 hours. Then the polymer was obtained by precipitation in acetone. The polymer was washed with acetone and dried in an oven at 60° C. for 24 hours; chemical shift of a tetramethylguanidine peak from 2.6 to 3.7 ppm and a new peak at 3.4 ppm due to methylation.

### 2. Production of Blend Membranes from Reaction Product 4.1 and F₆PBI

### 2.1 Blend Membrane Preparation

M-PPFSt-TMG polymer was dissolved in DMSO as a 5 wt % polymer solution. %. F₆PBI was dissolved in DMSO at 80° C. as a 5 wt % solution. The two polymer solutions were mixed together in specific ratios as described in the table. A polymer blend solution was cast onto a glass plate and placed in a convection oven at 80° C. for 24 hours to evaporate the solvent. The resulting mixed membranes were peeled from the glass plate by immersion in deionized water. The mixed membranes were stored in a ziplock bag for further use. Mixed membranes of M-PPFSt-TBF-OX-TMG with F₆PBI were prepared in the same way.

TABLE 2
Blend membrane preparation of M-PPFSt-TMG with F₆PBI

| | M-PPFSt-TMG/F₆PBI | |
|---|---|---|
| membranes | (w/w) | observation |
| M-PPFSt-TMG 80-20 | 80/20 | too much swelling |
| M-PPFSt-TMG 70-30 | 70/30 | stretchy |
| M-PPFSt-TMG 60-40 | 60/40 | stretchy |
| M-PPFSt-TMG 50-50 | 50/50 | stretchy |

TABLE 3
Blend membrane preparation of M-PPFSt-OX-TBF-TMG with F₆PBI

| | M-PPFSt-TMG/F₆PBI | |
|---|---|---|
| membranes | (w/w) | observation |
| M-PPFSt-TBF-OX-TMG 70-30 | 70/30 | heterogeneous membrane |
| M-PPFSt-TBF-OX-TMG 60-40 | 60/40 | heterogeneous membrane |
| M-PPFSt-TBF-OX-TMG 50-50 | 50/50 | heterogeneous membrane |

### 2.2 Blend Membrane Properties

TABLE 4
Blend membrane properties

| | IEC | Conductivity in 1 M | Conductivity in 1 M | water absorption |
|---|---|---|---|---|
| membrane | (mmol/g) | NaCl (mS/cm) | H₂SO₄ (mS/cm) | (%) |
| M-PPFSt-TMG 80-20 | 2.46 | 61.7 | — | — |
| M-PPFSt-TMG 70-30 | 2.47 | 14.2 | 43 ± 7.8 | 21 ± 1.9 |
| M-PPFSt-TMG 60-40 | 2.72 | 1.31 | 33 ± 4.0 | 17 ± 0.9 |
| M-PPFSt-TMG 50-50 | 2.91 | 0.44 | 22 ± 4.6 | 17 ± 4.0 |

— omitted due to excessive swelling

### 2.3 Vanadium Redox Flow Battery Performance

2.3.1 Coulombic Efficiency (CE), Voltage Efficiency (VE) and Energy Efficiency (EE)

The Coulombic Efficiency (CE) (a), Voltage Efficiency ( ) VE (b) and Energy Efficiency (EE) (c) of blend membranes and a Nafion 212 membrane are shown in FIG. 23.

2.3.2 Self-Discharge Test

The self-discharge test of mixed membranes and a Nafion 212 membrane can be found in FIG. 24.

2.3.3 Long Term Cycling Test

The results of the long-term cycling test of blend membranes and of a Nafion 212 membrane can be found in FIG. 25.

### 3. Reaction of Poly (Pentafluorostyrene) with 1-(2-Dimethylaminoethyl)-5-Mercaptotetrazole Followed by Reaction with Tetramethylguanidine

### 3.1 Reaction of Poly(Pentafluorostyrene) with 1-(2-Dimethylaminoethyl)-5-Mercaptotetrazole

The grafting of 1-(2-dimethylaminoethyl)-5-mercaptotetrazole onto poly (pentafluorostyrene) was performed according to the literature (if published, degree of substitution: 30%). Tetramethylguanidine was introduced onto partially grafted PPFSt-MTZ. 1 g of partially substituted PPFSt-MTZ was dissolved in 20 ml of DMAc equipped with a condenser, argon inlet and argon outlet. After completely dissolving at 90° C. for 1 hour, tetramethylguanidine was added into the polymer solution and kept at 130° C. for 24 hours. The polymer solution was precipitated in water. The polymer obtained (PPFSt-MTZ-TMG) was washed several times with water and dried in an oven at 60° C. for 24 hours.

Methylation: Methylation was carried out with dimethyl sulfate at 90° C. However, at this temperature a precipitate was observed.

### 4. Crosslinked Membranes of Partially Modified PPFSt and 1,6-Hexanedithiol

### 4.1 Production of Crosslinked Membranes (XL-M-PPFSt-MTZ)

In a glass vial, 0.3 g M-PPFSt-MTZ (prepared according to the literature, if published, 41% DOS) was dissolved in 10 ml DMSO. After complete dissolution, triethylamine (0.27 g) and 1,6-hexanedithiol (0.19 g) are added to the polymer solution. After homogenization, the mixed solution was poured into a Petri dish. This is placed in a closed oven (or with Petri dish cover) at 60° C. to ensure a reaction time of 1 day, followed by 8 hours at 120° C. with vacuum to remove residual chemicals. As shown in figure (b), a mechanically stable crosslinked membrane was obtained. The IEC of XL-M-PPFSt-MTZ was 0.28 mmol/g and the conductivity measured in 1 M H₂SO₄ was 1.77±0.18 mS/cm. Even the IEC and conductivity were lower compared to mixed membranes. Crosslinking using dithiol compounds is a possible fabrication route to obtain the mechanically stable membranes since the homo-M-PPFSt-MTZ polymer membrane was mechanically unstable.

### 5. Reaction of Poly (Pentafluorostyrene) with 1-Hexanethiol Followed by Reaction with Tetramethylguanidine

### 5.1 Reaction of Poly (Pentafluorostyren) with 1-Hexanethiol

In a 500 mL 3-necked round bottom flask equipped with a reflux condenser and an argon inlet and outlet, PPFSt (10 g, 51.5 mmol) was dissolved in THF (200 mL) at 90° C. for 1 hour under argon flow. The 1-hexanethiol (3.8 mL, 27.1 mmol) and DBU (8 mL, 52.5 mmol) were added at this temperature and stirred for 15 hours. After cooling to room temperature, the viscous solution was slowly poured into isopropanol to form a yellowish precipitate. The resulting polymer was washed several times with isopropanol and dried in a forced air oven at 60° C. for 24 hours.

Yield: 9.8 g

¹⁹F NMR (400 MHz, CDCl3, ppm): −134 (s, 2.8F), −143 (s, 4.9F), −154 (s, 1F). −161(s, 2.1F) (FIG. 29)

¹H NMR (400 MHz, CDCl3, ppm): 0.90 (t, 1.8H), 1.27-1.54 (m, ca. 5H), 1.99 (s, 2H), 2.41 (s, 0.8H), 2.88 (s, 1.2H))(FIG. 30)

### 5.2 Reaction Between Product from 4.5.1 (PPFSt-TH) with Tetramethylguanidine

PPFSt-TH (8 g, 31.6 mmol) was dissolved in DMAc (200 mL) in a 500 mL 3-neck flask with condenser and argon flow at 130° C. for 2 hours. After cooling to room temperature, TMG (19.8 ml, 158 mmol) was dropped into the polymer solution and reacted at 130° C. for 24 hours. After cooling, the brownish reaction solution was precipitated dropwise in deionized water to obtain the polymer. The polymer was isolated by filtration and washed several times with deionized water. The final polymer was dried in a forced air oven at 60° C. for 24 hours.

Yield: 9.04 g

FIG. 31 shows the ¹H NMR (400 MHz, THF-d8, ppm).

### 5.3 Methylation Reaction Between Product from 4.5.2 (PPFSt-TH-TMG) and Dimethyl Sulfate (DMS)

PPFSt-TH-TMG (7 g, 24 mmol) was dissolved in DMAc (150 mL). After complete dissolution, DMS (20.5 mL, 72.1 mmol) was added to the reaction solution with a syringe. The reaction was maintained at 90° C. for 12 hours with vigorous stirring. The reaction solution was then added dropwise to diethyl ether and washed twice with diethyl ether and once with deionized water. The resulting polymer was dried in a vacuum oven at 60° C. under 1 mbar for 24 hours.

Yield: 7.5 g

FIG. 32 shows the ¹H NMR (400 MHz, THF-d8, ppm).

### 5.4 Membrane Manufacture

An m-PBI was dissolved at 5.2% by weight in DMAc. The m-PBI solution was cast onto a glass plate and the solvent evaporated in a forced air oven at 80° C. for 24 hours. The membrane was then peeled off the glass plate by soaking in a water bath. The resulting membrane was dried at 90° C. for 12 hours and stored in a ziplock bag before use. A 5 wt % polymer solution of

M-PPFSt-TH-TMG was prepared by dissolving in DMAc. The solution was poured onto a Teflon sheet and placed in a forced air oven at 60° C. for 24 hours to evaporate the solvent. The membrane was removed from the glass support by immersion in water. The resulting membrane was conditioned by 10 wt % aqueous sodium chloride solution at 60° C. for 3 days, followed by 1 day immersion in DI water at 60° C., washed extensively with DI water and then stored in a zip-lock bag before further use (FIG. 33).

### 5.5 PA Doping of the Membranes

The PA doping was carried out by determining the weight before and after doping in aqueous PA solutions of different concentrations. Before PA doping, the membranes were dried at 6° C. for 24 hours, followed by measurement of their dry masses. The dried membrane samples were immersed in PA solutions at room temperature for 24 hours. The membrane samples were removed from the PA solution and blotted with a paper towel to remove phosphoric acid on the surfaces. Then the doped membranes were weighed (FIG. 34).

Doping level (%)=[(W_{after}−W_{dry})/W_{dry}]×100

W_{after}: membrane weight after PA doping, W_{dry}: membrane weight before PA doping

Acid doping level (ADL) PA/functional group=[(W_{after}−W_{dry})×0.85/97.99]/[(W_{dry}/IEC of the membrane)×1000]

W_{after}: Membrane weight after PA doping

W_{dry}: Membrane dry weight

IEC: Ion Exchange Capacity

The degree of substitution was calculated from the integral ratios between substituted and unsubstituted aromatic rings in NMR spectra. The theoretical ion exchange capacity (CEC) of membranes was calculated from the function of the IEC with the degree of substitution (obtained from NMR).

### 5.6 Thermal Stability (TGA)

To investigate the thermal stability of the synthesized polymers, a thermogravimetric analysis (TGA) was performed using a NETZSCH TGA, model STA 499C, coupled to FT-IR; accomplished. The temperature was raised at a heating rate of 20° C. per minute under mixed oxygen and nitrogen atmosphere (oxygen: 56 mL/min, nitrogen: 24 mL/min). (FIG. 35).

### 5.7 FT-IR Spectra

For the structural analysis of polymers, FTIR spectra were recorded at room temperature as a function of the wavenumber range from 4000 to 400 cm⁻¹ with 64 scans and the attenuated total reflection (ATR) mode using a Nicolet iS5 FTIR spectrometer (FIG. 36).

### 5.8 Fuel Cell Test

To fabricate a membrane-electrode assembly (MEA), a phosphoric acid-doped membrane was sandwiched between two electrodes. The gas diffusion electrode (GDE) was provided by Freudenberg and contained 1.5 mg Pt/cm² and the same electrodes were used on both the anode and cathode sides with an active area of 23.04 cm². The MEA was installed in a commercially available single cell, which had been sealed with a torque of 3 Nm. Fuel cell tests were performed using a commercial test station (Scribner 850e, Scribner Associates Inc.). Fuel cell performance was studied with non-humidified gases on both the anode and cathode sides at ambient pressure. The flow rates of H₂ at the anode and air at the cathode were 0.25 and 1.25 L/min, respectively (FIGS. 37, 38, and 39).

1. Partially or perfluorinated low and high molecular weight aromatic compounds containing tertiary N-basic groups, characterized in that they can be obtained by means of (i) an aromatic nucleophilic substitution by reaction of one or more F of the partially or perfluorinated compound with a secondary N-base:
a) 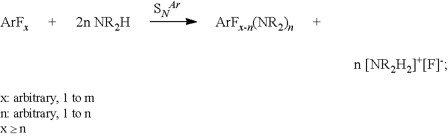
or (ii) an aromatic nucleophilic substitution by reaction of one or more F of the partially or perfluorinated compound with a secondary N-amide:

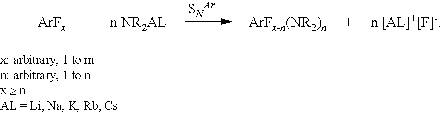

3. Partially or perfluorinated low or high molecular weight aromatic compounds containing quaternized N-basic functional groups, characterized in that they are obtainable by quaternizing the compounds containing tertiary N-basic groups according to claim 1 with an alkylating agent:

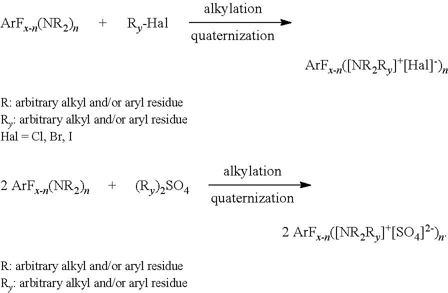

4. Partially or perfluorinated low or high molecular weight aromatic compounds containing quaternized N-basic functional groups, characterized in that they are obtainable by reaction of low or high molecular weight, partially or perfluorinated aromatic compounds with tertiary amines:

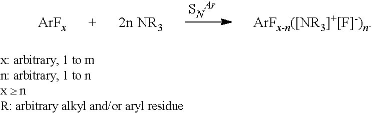

5. Partially or perfluorinated low or high molecular weight aromatic compounds containing quaternized N-basic functional groups and other functional groups, characterized in that they are obtainable by nucleophilic substitution reaction with organic low or high molecular weight compounds containing secondary and/or tertiary N-basic groups or other organic low or high molecular weight compounds capable of nucleophilic substitution in the following ways:
1. Reaction of perfluoroarene with secondary N-amide and a second nucleophile, followed by quaternization: 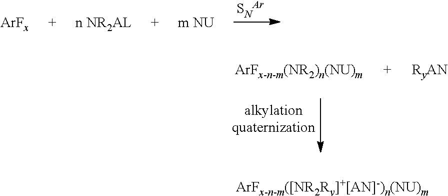
2. Reaction of perfluoroarene with secondary N-basic compound and a second nucleophile, followed by quaternization: 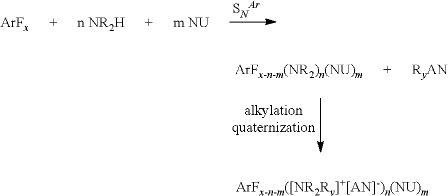
3. Reaction of perfluoroarene with tertiary N-basic compound and a second nucleophile in one step (one-pot reaction):

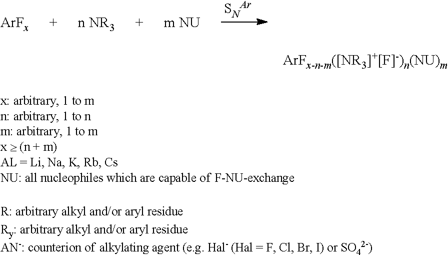

6. Compounds according to claim 1, characterized in that the organic compounds are high-molecular compounds with a molecular weight of between 1 kDa and 10,000 kDa.

7. Compounds according to claim 1, characterized in that the following polymers are used as partially or perfluorinated starting polymers:

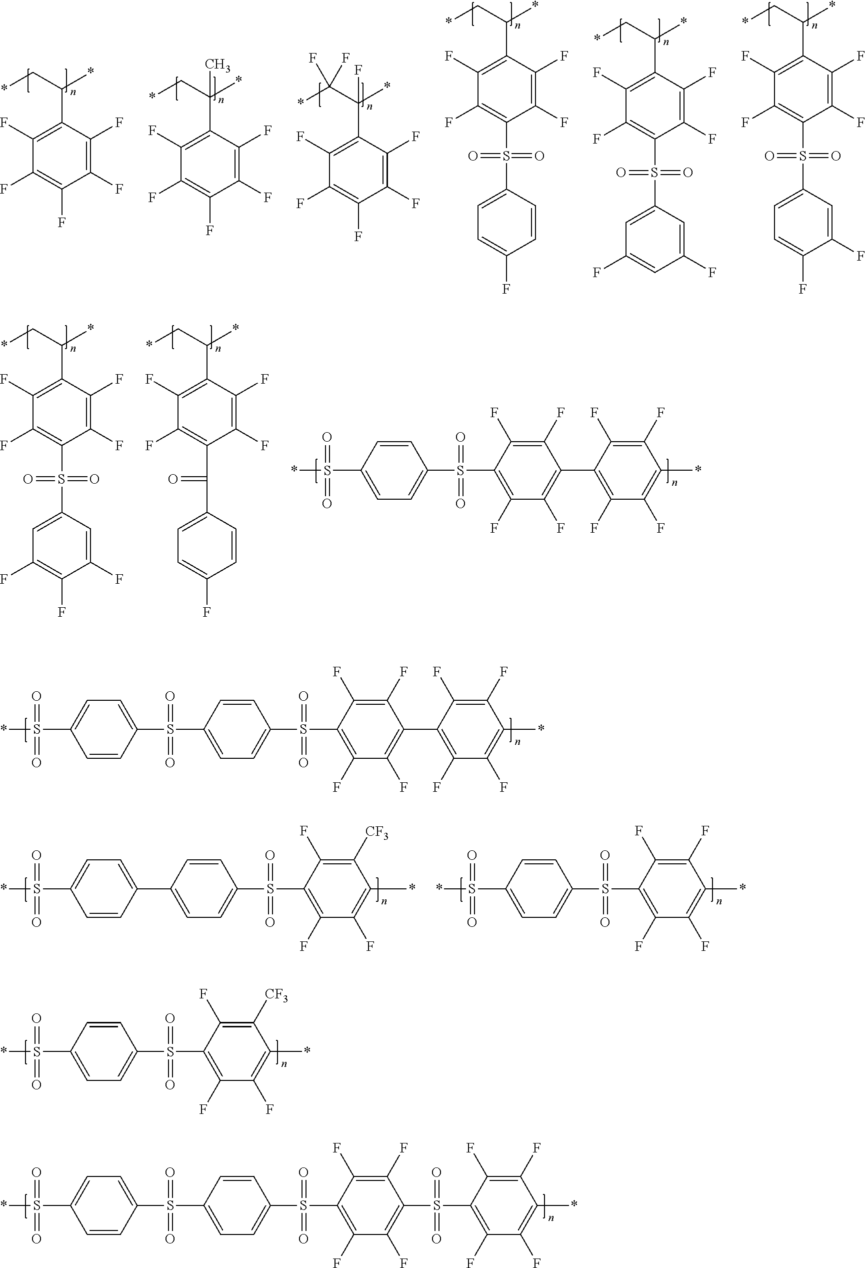

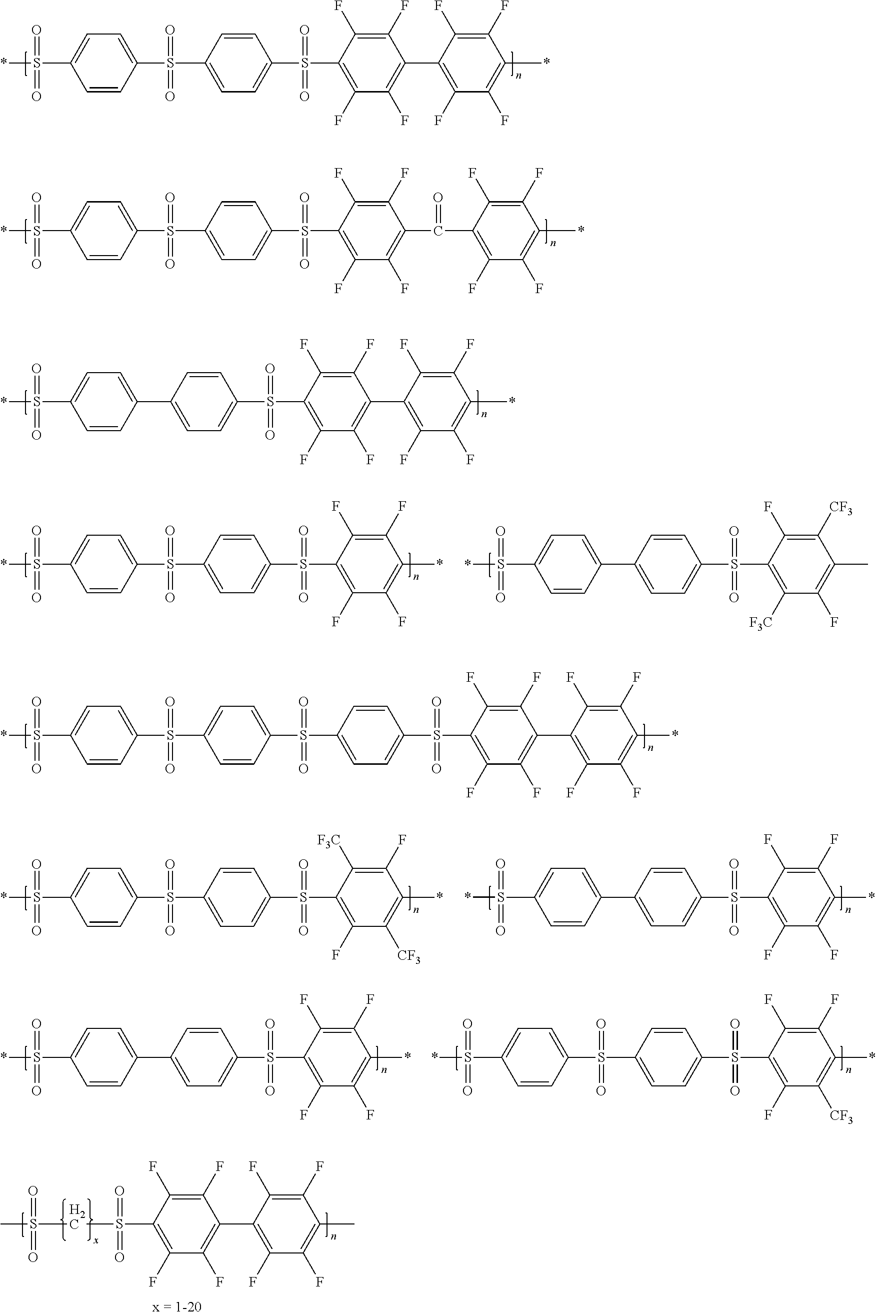

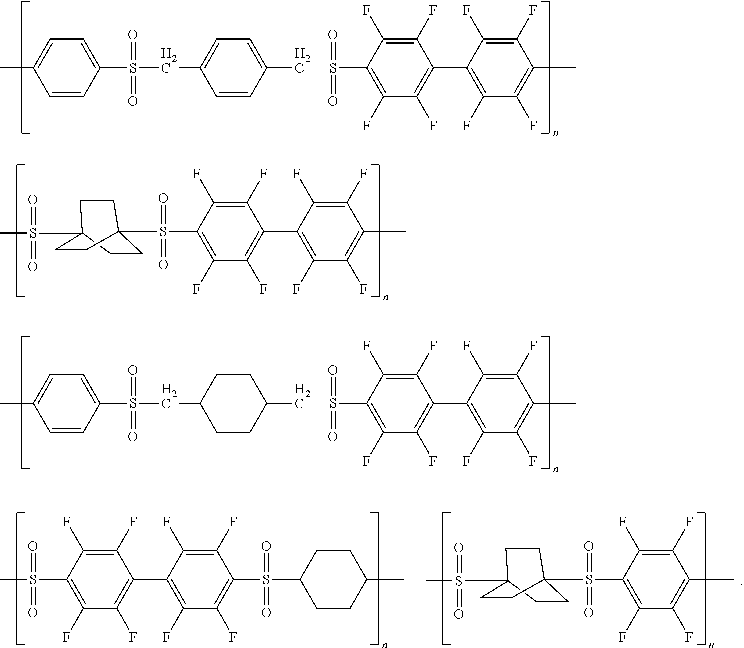

8. Compounds according to claim 1, characterized in that the following functional, tertiary and/or quaternary N-basic groups are used as the N-basic functional group introduced into the polymers:

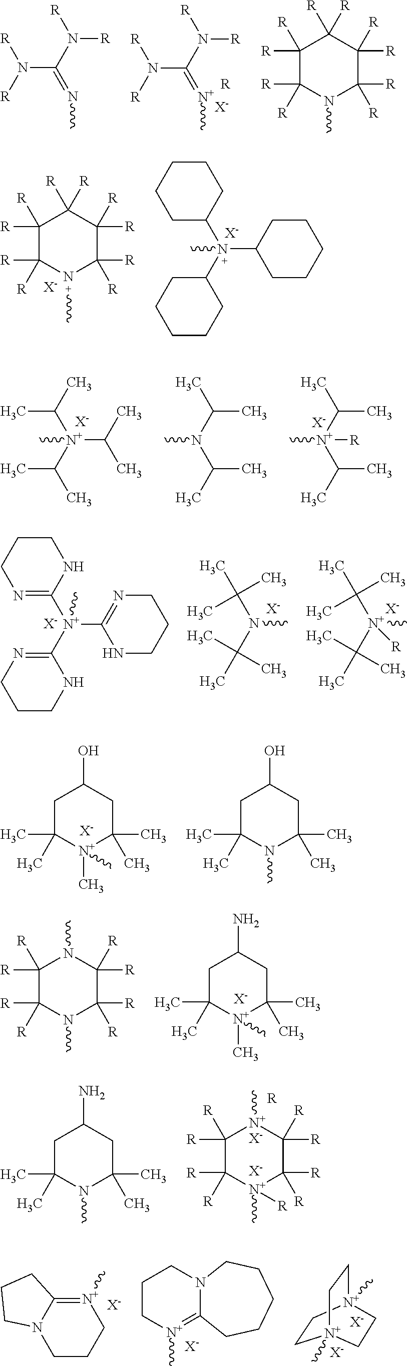

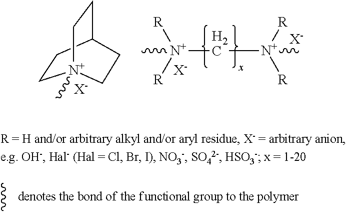

9. Compounds according to claim 1, characterized in that, in addition to the N-basic compounds, the following compounds are used as further nucleophiles which can be introduced into the polymers by nucleophilic F exchange:

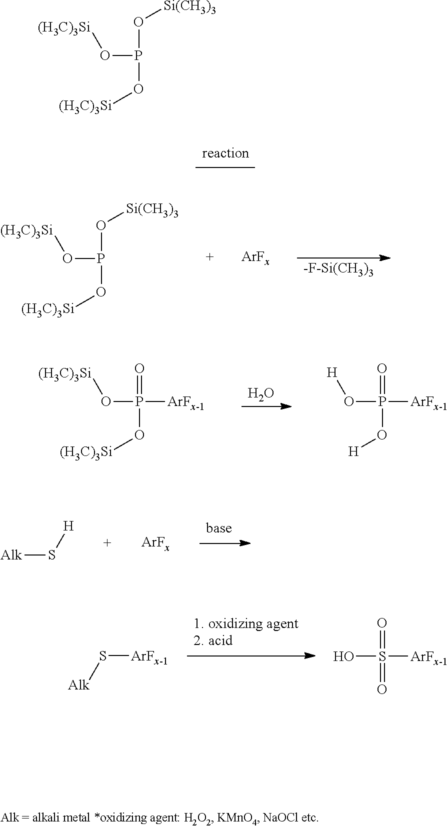

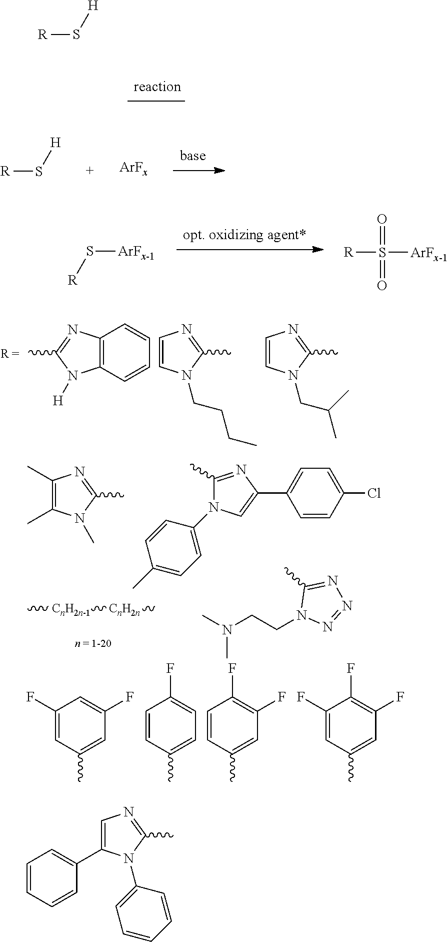

10. An ionically and/or covalently crosslinked blend membrane made from the oligomers or polymers according to claim 1, characterized in that the oligomers and/or polymers, dissolved separately in solvents, are mixed in any mixing ratio with the solutions of the following polymers:
sulfonated and/or phosphonated and/or carboxylated polymers,
basic polymers, where the basic polymers can have primary, secondary or tertiary N-basic groups in the side chain or the main chain,
halomethylated polymers, where the halomethyl groups can function as covalent crosslinking groups.

11. A process for the production of blend membranes according to claim 10, characterized in that the blend components are dissolved separately in dipolar-aprotic solvents and/or ether solvents and/or protic (alcohol) solvents and then the solutions are mixed with one another in any mixing ratios, thereafter the mixture solutions are doctor knife coated, sprayed or printed on a substrate, the solvent (mixture) is evaporated in a vacuum oven or a convection oven at an elevated temperature of 30 to 180° C., then the membrane formed is detached from the substrate and optionally in various steps as follows is after-treated in order to activate it, whereby the order of the after-treatments is arbitrary and can contain all or just a part of the after-treatment liquids listed below:
with deionized water at temperatures from 0 to 100° C.,
with a mineral acid solution of any concentration at temperatures from 0 to 130° C.,
with an alkali metal lye of any concentration at temperatures from 0 to 100° C.,
with any liquid tertiary N-base either in pure form or as a solution in water, in an alcohol and/or ether- and/or dipolar-protic solvents,
in an aqueous or alcoholic metal salt solution of any concentration at temperatures from 0 to 100° C.

12. The process for the production of blend membranes according to claim 11, characterized in that the solvent for the blend components is a dipolar-aprotic solvent selected from dimethyl sulfoxide, dimethyl sulfone, diphenyl sulfone, sulfolane, N,N-dimethylacetamide, N,N-dimethylformamide, N-methylpyrrolidinone, formamide and dimethyl carbonate.

13. The process for the production of blend membranes according to claim 11, characterized in that the mineral acid is selected from sulfuric acid, phosphoric acid, or hydrochloric acid of any desired concentration for the post-treatment/doping of the blend membranes.

14. The ionically and/or covalently crosslinked blend membranes according to claim 10, characterized in that the following polymer types are used as blend components of the polymers from claim 1:
as sulfonated, phosphonated or carboxylated polymers, polymers based on non-, partially- or perfluorinated vinyl hydrocarbon polymers, non-, partially- or perfluorinated polystyrenes or aryl main chain polymers including polyphenylenes, polyphenylene ethers, polyether sulfones, polyether ketones, polysulfones, polyketones, polyvinylcarbazoles, polyphenylenephosphine oxides,
as basic polymers, polymers of the polyimidazole or polybenzimidazole type, where the imidazole group or benzimidazole group may be present in the main chain or the side chain of the polyimidazoles or polybenzimidazoles,
as halomethylated polymers, chloro- or bromomethylated polymers including bromomethylated polyphenylene oxide, chloromethylated polyvinyl benzyl chloride or chloro- or bromomethylated polyphenylene.

15. An electrode ionomer comprising the polymers and blend membranes according to claim 1.

16. An electrode ionomer or an ionomer membrane comprising the blend membranes of claim 10.

17. The ionomer membrane of claim 10, wherein the ionomer membrane is incorporated in a fuel cell, electrolysis, a redox-flow battery, diffusion dialysis, electrodialysis, or a bipolar membrane with a cationic and anionic layer.
